(19) United States
(12) Patent Application Publication
(10) Pub. No.: US 2005/0288064 A1
(43) Pub. Date: Dec. 29, 2005

(54) CONTROL SYSTEM OF FUNCTION KEYS AND CONTROLLING METHOD THEREOF

(76) Inventors: Cheng-Shuo Lin, Taipei City (TW); Chih-Yuan Cheng, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/904,025

(22) Filed: Oct. 19, 2004

(30) Foreign Application Priority Data
Jun. 25, 2004 (TW) 93118438

(51) Int. Cl. H04B 1/38

(52) U.S. Cl. 455/564

(57) ABSTRACT

A function key control system integrating a function reminder menu, an assistant description menu and a function set-up menu and a controlling method thereof are provided. The controlling method comprises steps of using an embedded controller in an electronic equipment to detect that a first key is activated. The embedded controller transmits a trigger signal to fire up an application program. The application program opens and displays a function reminder menu. The embedded controller detects that a second key is activated and diagnoses a type of the second key. According to the type of the second key, either a function corresponding to the second key is performed or an assistant description menu and a function set-up menu are opened or the application program is terminated.

### CROSS-REFERENCE TO RELATED APPLICATION

This application claims the priority benefit of Taiwan application serial no. 93118438, filed Jun. 25, 2004.

### BACKGROUND OF THE INVENTION

1. Field of the Invention

The present invention relates to a control system of function keys and a controlling method thereof. More particularly, the present invention relates to a function key control system for an operating system by using a menu control system and a controlling method thereof.

2. Description of the Related Art

Conventionally, the key labeled Fn should be pressed together with a key selected from keys labeled F1 to F9 to start a built-in function, such as screen saver, standby function, touch pad switching function, screen-brightness adjusting or screen/external monitor switching function. However, it is not convenient to use this kind of function key controlling method since the user need to memorize the corresponding function of each key from F1 to F9 to properly select a key to operate a necessary function. Moreover, the function of each function key is built-in in keyboard or is well set in the operating system so that the user cannot extend or change the particular function key combination.

In order to overcome the problem mentioned above, Taiwan Patent No. 502269, entitled “Method for Constructing Multi-function Keys”, discloses a method of constructing multi-function keys, wherein the keyboard of the electronic equipment host possesses a least one undefined multi-function key or a trigger device for opening the multi-function operation menu. Moreover, the corresponding multi-function operation menu is also set up in the memory of the host of the electronic equipment.

Although the method described above provides the corresponding menu between multi-function keys and particular functions, the compatible hardware should possess keyboard controller to detect whether the multi-function keys or the trigger devices are pressed or not so as to transmit start signal to the host of the electronic equipment. Further, the mentioned method only provides the functions triggered by the combinations of Fn-key and keys labeled F1 to F9 but it does not provide the user the extension features to extend the control of the functions. Further, the multi-function operation menu only provides the user the corresponding between function keys and the particular functions but it lacks to provide assistant description or other parameter configuration.

### SUMMARY OF THE INVENTION

Accordingly, the present invention is to provide a function key control system possessing menu and a controlling method thereof, wherein the menu not only can provide the user reminders of the particular functions but also can integrate an assistant description and functional parameter configuration. Therefore, the user can choose and self-customize the function of the functional keys.

Moreover, in the present invention, the user can directly set up a multi-functional key. The user can self-customize a multi-function key without being limited by the built-in multi-function key.

Additionally, in the present invention, the hot key can be used as an adjustment key. When the user selects the functions of brightness or volume, the hot key can be also used as a key for turning up/down.

Furthermore, from the hardware point of view, there is not need to use the keyboard controller in the present invention and this feature of the invention is different from the prior art mentioned above.

To achieve these and other advantages and in accordance with the purpose of the invention, the invention provides a function key control system having a menu, wherein the system comprises a function reminder menu, a assistant description menu and a function set-up menu. The function reminder menu possesses a plurality of built-in functional options and a plurality of self-customized functional options. Moreover, the assistant description menu provides the user guide for the functional options mentioned above, and the assistant description menu prompts out when the user does not select the built-in functional options. Further, the function set-up menu provides at least one operating parameter for the built-in functional options and the self-customized functional options.

The present invention also provides a controlling method for a function key having a menu, wherein the method comprises steps of using an embedded controller (EC) to detect whether a first key is activated. The EC transmits a trigger signal to a basic input/output system (BIOS) and an operating system (OS) and then the OS start on an application program to open and display a function reminder menu. Users can directly press a predefined key to perform a corresponding action. If an option is pointed by using arrow keys or a mouse, an assistant description menu is displayed. If an un-defined key is pressed, the OS terminates this function key control system.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schema showing an operating interface according to one preferred embodiment of the present invention.

FIG. 2 is a flow chart according to one preferred embodiment of the present invention.

FIG. 3 is a flow chart according to another preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

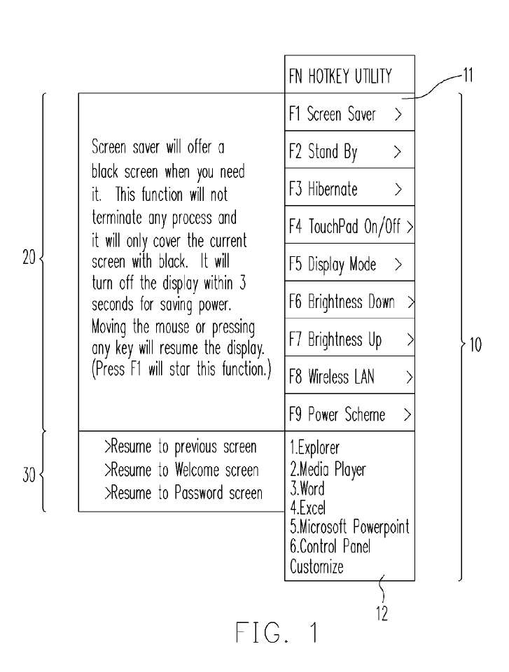

FIG. 1 is a schema showing an operating interface according to one preferred embodiment of the present invention. As shown in FIG. 1, a function key control system possessing a menu is provided. The function key control system comprises a function reminder menu 10, an assistant description menu 20 and a function set-up menu 30.

The function reminder menu 10 has built-in functional options 11 and self-customized functional options 12. The built-in functional options 11 include screen saver, standby, system hibernation, touch pad on/off switch, screen/external monitor switch (display mode), screen brightness adjusting, wireless LAN switch, power scheme, volume tuner and resolution switch. The self-customized functional options 12 can be set up to a short cut to a self-customized application program, such as Windows Office including Word, Excel and Outlook.

When none of the built-in functional options 11 is directly selected, the assistant description menu 20 prompts out. The assistant description menu 20 provides a user guide of the built-in functional options. For example, when the cursor is placed over the screen saver option, the assistant description menu prompts out to display a description as following: “Screen saver will offer a black screen when you need it. This function will not terminate any process and it will only cover the current screen with black. It will turn off the display within 3 seconds for saving power. Moving the mouse or pressing any key will resume the display. (Press F1 will start this function.)”.

Moreover, the function set-up menu provides at least one operating parameter for the built-in and self-customized functional options 11 and 12. For example, when the cursor is placed on the screen saver option, the function set-up menu 30 prompts out to display the following options: “Resume to previous screen, Resume to Welcome screen, Resume to Password screen”.

The present invention provides another direct control method. When a user selects a function for adjusting the brightness of the screen, the corresponding keys are F6 for turning up and F7 for turning down. Since the brightness of the screen is consecutively adjusting, it can be continuously pressing key labeled as F6/F7 to turn up/down the brightness of the screen. The method mentioned above can also be used to adjust the volume.

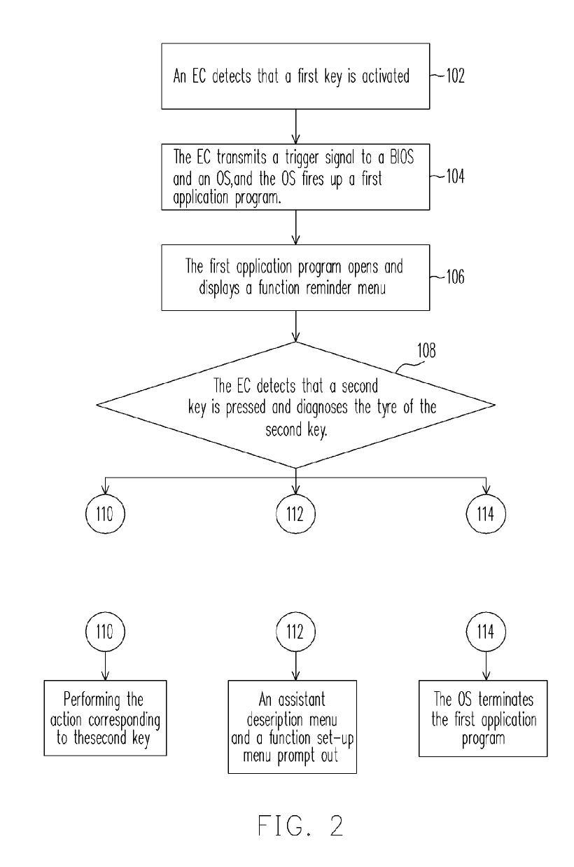

FIG. 2 is a flow chart according to one preferred embodiment of the present invention. As shown in FIG. 2, the present invention further provides a controlling method for a function key having a menu. The method comprises the following steps. In the step 102, an EC in an electronic equipment detects that a first key is activated, wherein the first key can be Fn key and the EC is used to transmit input/output signal or signals in peripheral device. In the step 104, the EC transmits a trigger signal to a BIOS and an OS and the OS fires up a first application program, wherein the first application program is a function key control system and the system comprises a function reminder menu, an assistant description menu and a function set-up menu. In the step 106, the first application program opens and displays the function reminder menu, wherein the function reminder menu has built-in functional options and self-customized functional options. The built-in functional option can be, for example, screen saver, standby, system hibernation, touch pad on/off switch, screen/external monitor switch (display mode), screen brightness adjusting, wireless LAN switch, power scheme, volume tuner or resolution switch. The self-customized functional option can be, for example, set up to a short cut to a self-customized application program. In the step 108, the EC detects that a second key is pressed and diagnoses the type of the second key. If the pressed second key is a pre-defined key, the step 110 is performed. If the pressed second key is one of arrow keys or the keys on a mouse, the step 112 is performed. If the pressed second key is an un-defined key, the step 114 is performed.

In the step 110, a function corresponding to the pre-defined key is performed, wherein the pre-defined key can be, for example, one of the keys labeled F1 to F9 or a self-customized key. Moreover, the function can be, for example, screen-saver function corresponding to F1, stand-by function corresponding to F2, system hibernation function corresponding to F3 or a self-customized function, such as a short cut to a second application program. In the step 112, the assistant description menu and the function set-up menu prompt out since none of the pre-defined key is directly selected but the arrow keys or the mouse are used to select a particular functional option. In the step 114, the OS terminates the first application program.

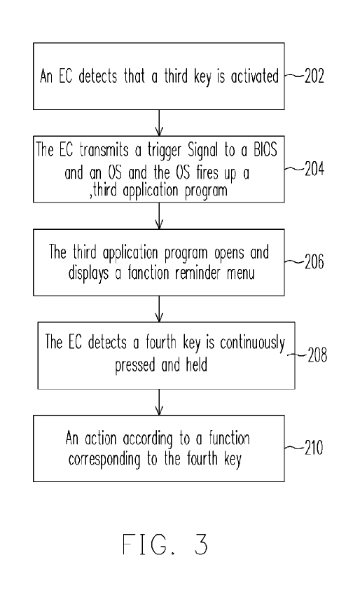

Referring to FIG. 3, a flow chart according to another preferred embodiment of the present invention is shown. The present invention provides another directly control method capable directly continuously adjust particular functions, wherein the method comprises the following steps. In the step 202, an EC in an electronic equipment detects that a third key is activated. In the step 204, the EC transmits a trigger signal to a BIOS and an OS and the OS fires up a third application program. In the step 206, the third application program opens and displays the function reminder menu. In the step 208, the EC detects that a fourth key is continuously pressed and held, wherein the fourth key corresponds to a consecutive adjusting function, such as adjusting brightness or volume. In the step 210, an action according to the consecutive adjusting function is directly performed.

In the present invention, the function reminder menu, assistant description menu and function set-up menu are integrated to provide a complete user guide for using the function keys and the users do not need to memorize the function keys and the corresponding functions. Even if the users already know the corresponding function of a function key, the function can be performed by using combination key (pressing Fn and a key selected from F1 to F9 at the same time).

Moreover, the function control system in the present invention not only provides the function keys capable performing built-in functions, but also provides the self-customized function keys to increase the extendable.

Furthermore, in the present invention, the detection function is integrated in the embedded controller (EC). The EC delivers a scan code to a keyboard regularly. When the particular keys or trigger devices are pressed, the EC senses the movement and transmits a trigger signal to a BIOS and a OS. Comparing to the mentioned key board controller which automatically transmits controlling signal, the cost of the hardware can be decreased in the present invention since EC is used to passively detect movement and transmit signal.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A function key control system having a menu feature, comprising:
a function reminder menu, wherein the function reminder menu possesses a plurality of built-in functional options and a plurality of self-customized functional options;
an assistant description menu, wherein the assistant description menu prompts out when none of the built-in functional options and the self-customized functional options are selected; and
a function set-up menu providing at least one operating parameter for the built-in functional options and the self-customized functional options.

2. The function key control system of claim 1, wherein the built-in functional options include a screen saver function, a standby function, a system hibernation function, a touch pad on/off switch, a screen/external monitor switch, a screen brightness adjusting, a wireless LAN switch, power scheme, a volume tuner or a resolution switch.

3. The function key control system of claim 2, wherein the screen brightness adjusting possesses a feature of consecutively adjusting.

4. The function key control system of claim 1, wherein the assistant description menu provides a user guide for the built-in functional options.

5. The function key control system of claim 1, wherein a short cut of an application program can be set in the self-customized functional options.

6. A controlling method for a function key having a menu feature, comprising the steps of:
using an embedded controller in an electronic equipment to detect that a first key is activated;
transmitting a trigger signal from the embedded controller to a basic input output system and an operating system, wherein the operating system fires up a first application program;
opening and displaying a function reminder menu by the first application program, wherein the function reminder menu comprises a plurality of options;
using the embedded controller to detect that a second key is activated and to diagnose a type of the second key;
performing a first function corresponding to the second key if the second key is a pre-defined key;
opening an assistant description menu and a function set-up menu by the first application program if the second key is one of arrow keys or mouse used to select an option from the function reminder menu; and
terminating the application program by the operating system if the second key is a key other than the pre-defined keys and the arrow key and the mouse.

7. The method of claim 6, wherein the first application program is a function key control system having a menu feature including a function reminder menu, an assistant description menu and a function set-up menu.

8. The method of claim 6, wherein the first key can be a key labeled Fn.

9. The method of claim 6, wherein the second key can be a key selected from keys labeled F1 to F9.

10. The method of claim 6, wherein the second key can be a self-customized key with a corresponding self-customized function.

11. The method of claim 6, wherein the function reminder menu possesses a plurality of built-in functional options and a plurality of self-customized functional options.

12. The method of claim 11, the built-in functional options include a screen saver function, a standby function, a system hibernation function, a touch pad on/off switch, a screen/external monitor switch, a screen brightness adjusting, a wireless LAN switch, power scheme, a volume tuner or a resolution switch.

13. The method of claim 11, wherein a short cut of a second application program can be set in the self-customized functional options.

14. A controlling method for a function key having a menu feature, comprising the steps of:
using an embedded controller in an electronic equipment to detect that a first key is activated;
transmitting a trigger signal from the embedded controller to a basic input output system and an operating system, wherein the operating system fires up a first application program;
opening and displaying a function reminder menu by the first application program;
using the embedded controller to detect that a second key is continuously pressed and held; and
performing an action directly according to a function corresponding to the second key.

15. The method of claim 14, wherein the function can be a screen brightness adjusting function.

16. The method of claim 15, wherein the second key corresponds to the screen brightness adjusting function.

17. The method of claim 14, wherein the function can be a volume tuner.

18. The method of claim 17, wherein the second key corresponds to the volume tuner.

19. The method of claim 14, wherein the first key can be a key labeled Fn.
